(19) United States
(12) Patent Application Publication
(10) Pub. No.: US 2010/0263315 A1
(43) Pub. Date: Oct. 21, 2010

(54) MOLDED SIDING HAVING INTEGRALLY-FORMED I-BEAM CONSTRUCTION

(75) Inventors: John Richard Logan, Oxford, MI (US); Thomas J. Baker, Dryden, MI (US)

Correspondence Address: HOWARD & HOWARD ATTORNEYS PLLC, 450 West Fourth Street, Royal Oak, MI, 48067, US

(73) Assignee: TAPCO INTERNATIONAL CORPORATION, Wixom, MI (US)

(21) Appl. No.: 12/762,897

(22) Filed: Apr. 19, 2010

Related U.S. Application Data
(60) Provisional application No. 61/170,180, filed on Apr. 17, 2009.

(51) Int. Cl. E04C 2/38; B28B 5/02; B29C 67/20

(52) U.S. Cl. 52/519; 425/471; 264/49

(57) ABSTRACT

A molded siding member having a plurality of longitudinal support portions extending substantially the entire length of the member contained therein, each support portion presenting a cross-section generally shaped like that of an I-beam. The support portions, which are parallel and adjacent to each other, are integrally formed with the siding member from cementitious slurry, including gypsum cement and a latex/water mixture, or hydraulic cement. An amount of the slurry is added to a mold in which longitudinally-oriented core elements are provided that displace cementitious slurry between and define adjacent support portions. After sufficient curing, the siding member is removed from the mold and is ready for immediate use and/or further processing. Alternatively, a continuous method is also provided for producing relatively long lengths of the siding that can be cut to an appropriate size, without the need to produce individual siding members of limited size.

### CROSS-REFERENCE TO RELATED APPLICATION

This application claims priority to U.S. Provisional Application No. 61/170,180 filed Apr. 17, 2009, the complete disclosure of which is incorporated herein by reference.

### FIELD OF THE INVENTION

The present invention relates generally to siding systems, and more specifically to siding systems formed from cementitious slurries, especially those containing gypsum.

### BACKGROUND OF THE INVENTION

Many homes in North America use brick, vinyl siding, aluminum siding, or wood as the material comprising the exterior walls thereof. Brick provides excellent aesthetic, weather protection, and insulation properties, and is virtually maintenance free. However, brick is considerably more expensive to install than the other three primary siding materials due to the high labor costs.

Vinyl siding is made from PVC (polyvinyl chloride) and has begun to be used in construction more and more all the time. Vinyl siding can be fashioned to resemble wood, with the average width of vinyl siding ranging from 6 inches to 10 inches. However, other various lengths and widths are available. Scratches are rarely visible, because the PVC that the siding is composed of is solid all the way through. Vinyl siding is similar in many properties to aluminum, such as weight and density. However, unlike aluminum, vinyl does not dent, and besides aesthetic repair, scratched vinyl siding does not rust and will not ruin the integrity of the siding. Temperature will not affect vinyl siding, which can be installed in nearly any climate. Aluminum siding might take a long time to re-install if damaged, which is untrue of vinyl siding. Vinyl's temperature at which it ignites is very high (736° F.), and it has half the burn time of cedar and burns one third as hard.

Aluminum siding is also one of the most popular exterior home coverings. It is more common than steel siding systems because steel tends to rust when exposed for a long period of time, unlike aluminum. Like vinyl siding, aluminum siding is relatively low-maintenance in its first few years. Aluminum siding comes in long panels, so it takes less time to install. It has baked on enamel that can be flat or shaped to resemble wood grain. Aluminum siding is waterproof, a good insulator, and the most fireproof type of siding. Unfortunately, aluminum siding is susceptible to dents and can be difficult to repair once it's been completely installed. For the first few years, aluminum siding requires little maintenance. However, it soon may show signs of cracking, corrosion, and peeling. After two or three years, the home owner should begin monitoring the aluminum siding for dents and other marks. Eventually, damaged panels should be repainted or replaced, which is a time-consuming and potentially expensive process.

The most common type of siding for a house is wood (e.g., cypress, cedar, redwood, and/or the like) which provides an attractive appearance and good insulation properties. However, as evidenced by the fact that more and more consumers are choosing vinyl, aluminum, and other siding choices, there are a number of drawbacks.

Wood in general is a haven for animals and insects. For example, many woodpeckers and other birds are drawn to the wood on the outside of houses. It is thought that tannin, a resin that is found in cedar is a natural insect repellent. However, the same tannin can cause rain spots that will appear for the first three years that the cedar is on the home. Redwood is much like cedar except that its color is slightly different.

Plywood, which is a common type of siding, is usually composed of western red fir, yellow pine, and Douglas fir. Either roughhewn or smooth, plywood is usually attached to a home horizontally and isn't the best way to protect from water damage. However, plywood is attractive for its natural look, and many ways are being developed to strengthen its structural integrity. Clapboard is simply long boards of wood applied horizontally and overlapping on a house. The result can look uneven and irregular, but beveled or tapered boards can correct this problem. Hardboard or composition board is comprised of compressed wood fiber and adhesives that are weather resistant and applied to planks or sheets of wood to strengthen them and make them more waterproof. Hardboard can measure 16 feet in length, though many people have it cut to better resemble clapboard. Plywood siding is comprised of a veneer, which is a slice of wood of constant thickness, and it is applied to hardwood to form hardwood siding. More durable than indoor plywood, it is also much more waterproof. Rectangular plank siding is comprised of smooth planks that meet each other evenly. When laid vertically, they form a flat surface that is interrupted only by battens designed to keep moisture out. Wood plank siding is very much like rectangular plank siding in that boards are laid vertically and protected from water damage. However, wood plank siding comes in many shapes and can be cut many different ways to give texture and a pattern.

A rustic, pastoral look can be achieved by using shake siding, which is made up of hand-split, irregular cedar sidings. They are rough and either put on all at once or in layers to use weathering as an effect for patterns. They are susceptible to cracking, warping and curling, so they should be checked often and replaced when necessary. Unlike shakes, sidings are machine cut, smooth and uniform. They are increasingly overlapped as they are higher on the house, however many people create their own patterns and decide the degree to which there is an overlap. Like shakes, sidings can fall victim to warping, cracking, and curling.

Any wood siding product, but especially less protected wood like shakes and sidings, should be kept away from moisture and protected from the elements. Typically this involves the regular application of stains, sealants, and paints, and is generally an expensive and time-consuming process. Failure to properly maintain the wood siding product can lead to irreparable damage and potential rotting of the wood, necessitating expensive repairs.

A recent product in the siding market has been asbestos-free fiber-cement siding. Its market share is on the rise, but it still lags behind wood and vinyl siding. Fiber-cement siding generally is more expensive than aluminum or vinyl siding, but it costs less than brick or traditional cedar siding. It is sold under a number of brand names, including HARDIPLANK, CEMPLANK, and WEATHERBOARDS. To make the siding, manufacturers mix cement, sand and cellulose fibers with water. The planks are offered in various widths in both horizontal and vertical styles. They can be given a smooth look or finished with a heavier wood grain appearance. James Hardie Building Products, which makes the HARDIPLANK line, has introduced a plank that simulates the look of sidings to use as an accent on a home. A big selling point of fiber-cement siding is that it offers a number of benefits over wood. For example, this siding resists damage from the elements and insects, and provides very good structural strength and good impact resistance. From a safety standpoint, the fiber-cement siding itself won't burn, but the finishing materials (e.g., paints) applied thereto might. Although makers of the fiber-cement siding tout its low-maintenance qualities, it does, as noted, need to be painted periodically. Attaching fiber-cement siding to a home is similar to applying wood siding; however, this type of siding is heavier, more difficult to cut, and generally more difficult to install than traditional siding materials.

Another recent development in siding products is molded reinforced cementitious siding. Such siding is comprised of cement, or a cementitious exterior shell at least partially enveloping an optional foam core, wherein the cementitious materials especially contain gypsum (e.g., calcined gypsum). The siding system members are formed from cementitious slurry comprising gypsum cement (e.g., calcined gypsum) and a latex/water mixture. The slurry can also contain other materials, such as but not limited to reinforcement materials (e.g., fibers, scrims, netting, meshes, and/or the like), as well as other materials that are known in the art (e.g., activators, set preventers, plasticizers, fillers, and/or the like), which can be added before and/or after the combination of the gypsum and latex/water mixture. The slurry is introduced into the mold over a previously-inserted meshed reinforcement material, such as a fiberglass mat. The slurry impregnates and envelops the mat, which adds considerable flexibility to the resulting product without it breaking, as would occur in a product formed only of the hardened slurry, even with the inclusion of aggregate reinforcement materials contained in the slurry. Even with the flexing capabilities afforded with meshed or matted reinforcement materials, such siding members can be difficult to handle in long lengths (e.g., of several feet in length), which are typically used in many siding applications where wood siding is simulated.

This is in part due to a lack of member rigidity, which is overcome in part by the inclusion of a foam core. But another factor contributing to this handling problem stems from supporting elongate cementitious members at perhaps only one or two localized positions along its length, which can impart significant bending stresses in the cementitious material, at or between the localized support location(s), where bending is greatest. The bending moment acting on a member at these high stress sites typically result from the member being supported only at or near the midpoint of its length, or being supported only at or near its opposite ends. This is particularly problematic when the planar member is supported in a substantially horizontal orientation.

Therefore, it would be advantageous to provide durable and economical siding systems, and methods for forming the same, which overcome at least one of the aforementioned problems.

### SUMMARY OF THE INVENTION

The present invention provides a siding member, and methods for forming the same, wherein the siding member includes an integrally-formed I-beam construction. The siding member may be formed in a mold from cementitious slurry comprising gypsum cement (e.g., calcined gypsum) and a latex/water mixture, or comprising hydraulic cement. The slurry can also contain other materials, such as but not limited to reinforcement materials (e.g., fibers, scrims, netting, meshes, and/or the like), as well as other materials that are known in the art (e.g., activators, set preventers, plasticizers, fillers, and/or the like), which can be added before and/or after the combination of the gypsum and latex/water mixture, or mixing of the hydraulic cement. The present invention also provides an alternative continuous method for producing relatively long lengths of the siding that can be cut to an appropriate size, without the need to produce individual siding members of limited size.

The slurry is introduced into the mold or molding system over a plurality of parallel, longitudinal elements that substantially lie in a plane and extend substantially the entire length of the siding member being formed. These elements, referred to herein as “core” or “void producing” elements, which may remain in the finished product, need not themselves provide appreciable structural support to the siding member, but rather serve primarily to displace the cementitious slurry such that the slurry forms, when cured, an integral structure providing a plurality of adjacent, integrally-formed webs extending along the thickness of the siding member. In cross section, normal to the member's longitudinal axis, one or both of the opposite ends of each web portion is an integrally-formed flange portion that is merged or integrally joined with an adjacent such flange below the surface of at least the exterior face of the siding member, thus providing the siding member with an integrally-formed I-beam construction. Such a structure provides the siding member with an increased moment of inertia that increases siding member rigidity and its resistance to bending. Moreover, because cementitious material is displaced by the core elements, less of the cementitious material is used in each siding member, thereby decreasing the weight of the siding member and, depending on the materials used, its direct variable cost. This weight reduction also reduces indirect variable cost, in terms of fuel to transport the siding, and makes the siding easier to handle. Moreover, because of its increased rigidity and resistance to bending, as well as its relatively reduced weight, the individual siding members may be handled with reduced risk of breakage due to supporting it at perhaps only one or two localized positions along its length, even when being supported in a substantially horizontal orientation.

The core or void-producing elements located between the webs, which establish the longitudinally-extending webs and flanges internal to the siding member may be of any suitable and convenient material, structure or cross-sectional shape, such as but not limited to square or cylindrical foam backer rod, or thin-walled cylindrical plastic or paper tubing (much like a soda straw), and need not be adhered to the cementitious material in the final product. Indeed, the elements may degrade over time, leaving only a longitudinally extending channel or void in the cementitious siding material, although it is preferable that the elements not be of a material that would promote the growth of mold within the siding member. Alternatively, the core or void-producing elements may be integrated into an upper mold surface member that is interfitted to a lower mold surface member to form a closed mold into which the slurry is injected.

Maintaining the orientation of longitudinal elements that remain with the finished product prior to and during the molding process may be facilitated by an optional meshed scrim material to which is sprayed or otherwise applied an adhesive material. The longitudinal elements are distributed in parallel on the scrim fabric, and held in position thereon by the adhesive. Preferably, relative to the plane defined by the arrangement of core elements, the scrim material is located on the side on which the exposed, exterior face of the siding member will be formed, thereby improving the resistance of the exposed, molded siding surface to cracking due to any deflection of the siding member. The cementitious slurry is applied over the core elements and scrim, and flows through the scrim, to a desired depth that covers and encapsulates the scrim and the core elements.

Certain embodiments of the inventive siding and molding processes optionally provide at least one, and preferably a plurality of longitudinally extending support portions that extend substantially the entire length of each molded siding member. The fibers are immersed in the slurry and, once the slurry cures or hardens, are captured by the cementitious material and substantially prevented from moving relative thereto. The fibers may be tensionally prestressed such that in the resulting siding member, the fibers are under tension in the siding member's natural, undeformed state. Alternatively, the fibers may be subjected to tensile stresses only upon bending deformation of (or tension forces being exerted on) the siding member. The tensioned fibers aid in resisting bending deformation of the siding member, and places the siding member in a longitudinally directed compression, thereby reinforcing it against cracking or breaking, much as steel rebar does in reinforced concrete structures. Such siding and processes for its manufacture are taught in U.S. patent application Ser. No. 12/689,368 filed Jan. 19, 2010, by J. Richard Logan, et al. entitled MOLDED SIDING HAVING LONGITUDINALLY-ORIENTED REINFORCEMENT FIBERS, AND SYSTEM AND METHOD FOR MAKING THE SAME, the complete disclosure of which is expressly incorporated herein by reference.

The slurry can contain colorants dispersed therethrough, or alternatively, the mold surface that forms the exposed, exterior siding member surface can be coated with a colorant. In addition to the above-mentioned scrim and longitudinally-oriented fibers, a fabric of reinforcement material (e.g., fiberglass netting or mat, and/or the like) can be optionally added to the mold. Further, during one or more of the aforementioned stages, the mold or molding system can be vibrated and/or force/pressure applied. After an appropriate curing or drying time, the product (e.g., a molded siding member) is removed from the mold system and is ready for immediate use and/or further processing.

The present invention provides a siding system including at least one elongate member molded of cementitious material and having opposed front and back sides, the front side formed of cementitious material and having a front exterior face located on one side of an imaginary plane, the member including a plurality of longitudinally-oriented support portions that extends substantially the entire length of the member. Each support portion has a web portion that extends in a direction substantially normal to the plane and at least one flange portion, the webs of adjacent support portions separated by a longitudinally-oriented void in the cementitious material and located in the plane. Flange portions located on the same side of the plane as the member front side are integrally connected to each other. The support portions are subjected to compressive and tensile stresses during bending deformation of the member out of the plane, and the bending deformation of the member is resisted by the support portions.

The present invention also provides a molding system for forming an elongate siding member comprising a cementitious material that defines a plurality of longitudinally oriented support portions extending substantially the entire length of the siding member and longitudinally oriented voids in the cementitious material. The system includes a mold face defining at least a portion of a front exterior surface of the siding member, means for orienting void-producing elements relative to the mold face, and a cementitious material source from which a desired amount of cementitious material is received onto the mold face and at least partially envelops the void-producing elements.

The present invention also provides a method of molding an elongate siding member comprising cementitious material having a plurality of integrally-formed longitudinally oriented cementitious material support portions which extends substantially the entire length of the siding member, including the steps of: longitudinally-orienting void-producing elements over a mold face; receiving cementitious material onto the mold face; at least partially surrounding the void-producing elements with the cementitious material received onto the mold face; forming a front exterior surface of the siding member and a plurality of integrally-formed longitudinally-oriented support portions which extends substantially the entire length of the siding member from the cementitious material received onto the mold face; curing the formed cementitious material; and separating the siding member and the mold face.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an elevational view of a dwelling having a cementitious siding system, in accordance with a first embodiment of the present invention;

FIG. 1A is a partial perspective view of a dwelling having an alternative design cementitious siding system, in accordance with a second embodiment of the present invention;

FIG. 2 is a perspective view of a cementitious siding member, in accordance with a third embodiment of the present invention;

FIG. 2A is a perspective view of an alternative design cementitious siding member, in accordance with a fourth embodiment of the present invention;

FIG. 3 is a perspective view of the cementitious siding member of FIG. 2 or 2A, showing its reverse side;

FIG. 4A is a cross-sectional view of the cementitious siding member of FIG. 3 along line 4-4 thereof, in accordance with a fifth embodiment of the present invention;

FIG. 4B is a cross-sectional view of the cementitious siding member of FIG. 3 along line 4-4 thereof, in accordance with a sixth embodiment of the present invention;

FIG. 4C is a cross-sectional view of the cementitious siding member of FIG. 3 along line 4-4 thereof, in accordance with a seventh embodiment of the present invention;

FIG. 5A is a perspective view of a portion of a molding system for forming a cementitious siding member, in accordance with a eighth embodiment of the present invention;

FIG. 5B is a perspective view of a portion of a molding system for forming an alternative design cementitious siding system, in accordance with a ninth embodiment of the present invention;

FIG. 6 is an exploded view of a mold surface member and the bottom molding member, in accordance with a tenth embodiment of the present invention;

FIG. 7 is a perspective view of the bottom molding member on a conveyor system, in accordance with an eleventh embodiment of the present invention;

FIG. 8 is an exploded view of the mold surface member and the bottom molding member on the conveyor system, in accordance with a twelfth embodiment of the present invention;

FIG. 9 is an exploded view of core elements being placed into the mold surface member, in accordance with a thirteenth embodiment of the present invention;

FIG. 10 is an exploded view of core elements and scrim to which they may be adhered being placed into the mold surface member in accordance with an fourteenth embodiment of the present invention;

FIG. 11 is a perspective view of a cementitious slurry being introduced into the mold surface member, and over the core elements or over the scrim material and core elements, in accordance with a fifteenth embodiment of the present invention;

FIG. 12 is an exploded view of the lower mold surface member and mold retainer support of FIG. 8 on a conveyor system, an optional reinforcement material fabric, and an optional upper mold surface member for forming a siding member in accordance with a sixteenth embodiment of the present invention;

FIG. 13 is a perspective view of the mold assembly of FIG. 12 closed, on a conveyor system;

FIG. 14 is a sectional view taken along line 14-14 of FIG. 13, also showing the injection nozzle insertable into the sprue of the upper mold surface member, but omitting the optional reinforcement material fabric shown in FIG. 12;

FIG. 15 is a fragmented perspective view of a siding member molded in the mold system shown in FIGS. 12-14, showing the reverse face of the siding member;

FIG. 16 is an exploded view of the mold surface member containing a formed cementitious siding member being removed from the bottom molding member, in accordance with an eighteenth embodiment of the present invention;

FIG. 17 is an exploded view of a finished cementitious siding member being removed from the mold surface member in accordance with a nineteenth embodiment of the present invention;

FIG. 18 is a schematic view of a first alternative system for producing the cementitious siding members of the present invention, in accordance with a twentieth embodiment of the present invention;

FIG. 19 is a schematic view of a second alternative system for producing the cementitious siding members of the present invention, in accordance with a twenty-first embodiment of the present invention;

FIG. 20 is a edge-on view of a length of a cementitious siding member of the present invention, supported at the midpoint along its length and allowed to bend under its own weight; and

FIG. 21 is a edge-on view of a length of a cementitious siding member of the prior art, identical to the siding member of FIG. 20 except for excluding longitudinally-extending support portions, supported at the midpoint along its length and allowed to bend under its own weight.

It is to be noted that the Figures are not drawn to scale. In particular, the scale of some of the elements of the Figures is greatly exaggerated to emphasize characteristics of the elements. It is also noted that the Figures are not drawn to the same scale. Elements shown in more than one Figure that may be similarly configured have been indicated using the same reference numerals.

While the invention is susceptible to various modifications and alternative forms, specific embodiments thereof are shown by way of example in the drawings and may herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EXEMPLARY EMBODIMENTS

The following description of the preferred embodiment(s) is merely exemplary in nature and is in no way intended to limit the invention, or uses. It is to be noted that the Figures are not drawn to scale. In particular, the scale of some of the elements of the Figures is greatly exaggerated to emphasize characteristics of the elements. It is also noted that the Figures are not drawn to the same scale. Elements shown in more than one Figure that may be similarly configured have been indicated using the same reference numerals.

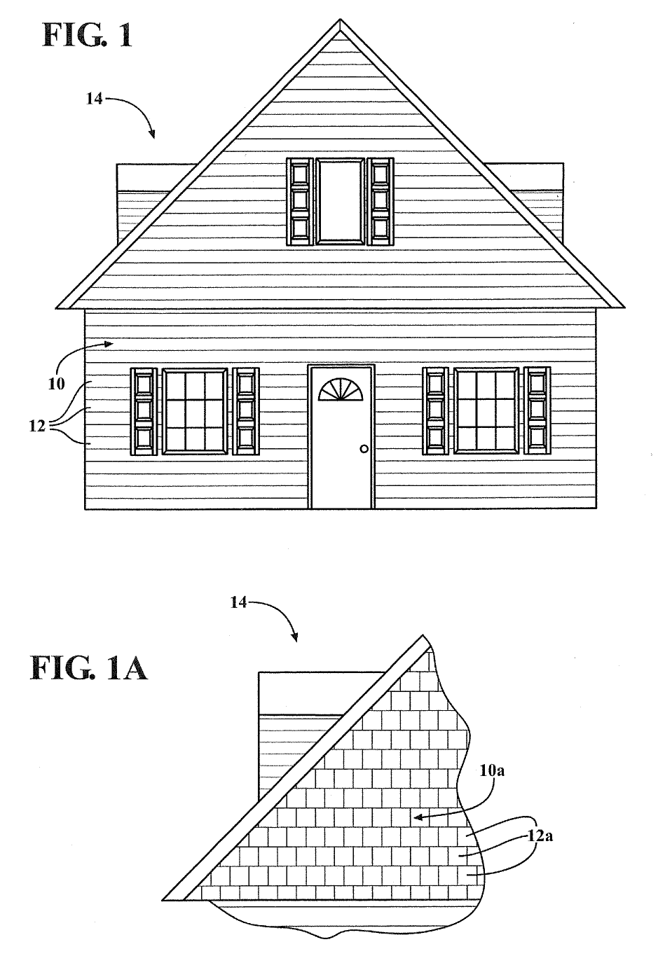

Referring to the Figures generally, and specifically to FIGS. 1 and 1A, a cementitious siding system is generally disclosed at 10 and 10a. By “system,” as that term is used herein, it is meant at least one siding member such as 12 or 12a, which may consist of one individually-formed siding member, two integrally formed siding members, and/or a plurality of integrally formed siding members, each siding member 12, 12a being substantially elongate and thereby benefiting most appreciably from the present invention. Although the present invention will be described with primary reference to siding systems or members, it should be appreciated that the present invention can be beneficially practiced with any type of elongate architectural and exterior/interior decorative element. Further, processes for the manufacture of, for example, cementitious trim members, casing members, roofing members or tiles, and other articles or systems including one or more longitudinally extending support portions, as well as such articles themselves, are intended to be within the scope of the present invention. Notably, such articles intended to be within the scope of the present invention need not be of a particular form, such as, for example, planar, or even elongate, but rather may be of any configuration benefiting from advantages provided by the present invention.

The siding system 10 can be mounted, either permanently or temporarily to a dwelling, such as a residential or commercial building. FIG. 1 shows an exterior front view of a house 14. The siding system 10 is rigidly secured to the exteriors walls by appropriate securing devices, such as but not limited to nails, bolts, screws, and/or the like. By way of a non-limiting example, the siding system 10 can be formed with apertures provided therein for receiving the securing devices.

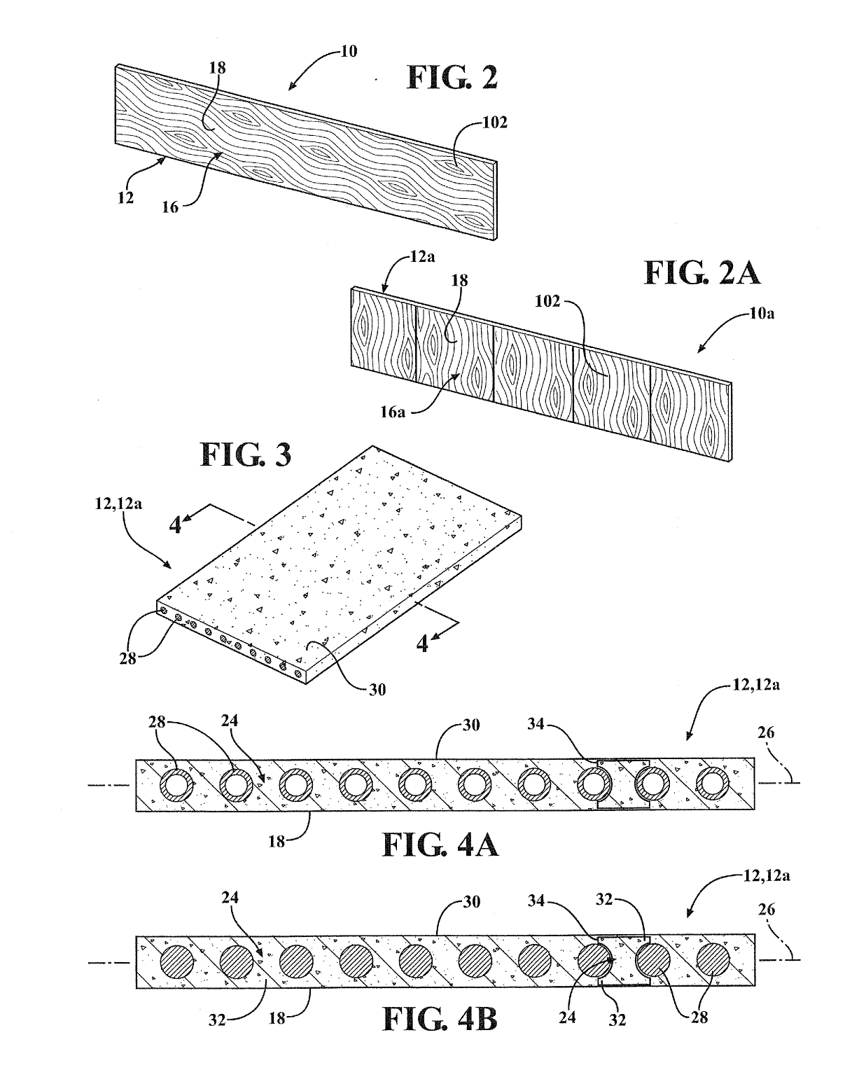

With specific reference to FIGS. 1A and 2A, an alternative design siding system 10a of the present invention can include, without limitation, a “cedar shake” or “cedar shingle” like appearance. In this view, the alternative design siding system 10a includes more than one siding member 12a, formed or placed side by side with one another.

It should be appreciated that the siding members of both siding systems 10, 10a can be cut (e.g., with a circular saw, table saw, tile saw, and/or the like) to desired length, but the integrally formed I-beam construction of the siding members as described below permits their installer and others to more easily handle them in long lengths (i.e., of several feet in length) with substantially reduced risk of the molded cementitious siding members breaking or cracking. As shown, siding systems 10, 10a of the present invention can include surface textures 16, 16a, respectively, on at least the front exterior face 18 of the siding member to mimic the look of wood grain or any other type of material. Additionally, the siding systems 10, 10a of the present invention can be installed in any number of patterns, e.g., the ground level can include siding system 10 and the second level or eaves can include siding system 10a.

The siding members 12, 12a have opposed front and back sides, with the front side having exposed, front exterior surface 18. The siding members include a plurality of longitudinally-oriented support portions 20 integrally formed of cementitious material that extend substantially the entire member length and through the siding member thickness. Voids 22 located between adjacent webs 24 of support portions 20 may be spaced at approximately ½ inch from each other, center to center, and lie in a plane 26 substantially coinciding with a plane defined by the illustrated siding member. In the description that follows, “void” shall refer to the space 22 between adjacent webs 24 whether completely hollow or devoid of any material, or filled with a core or void-producing element 28 made from other than cementitious material. Front exterior face 18 lies on one side of plane 26, and when the siding member is in a natural, undeformed state, may be substantially parallel therewith. Web portions 24 extend in a direction substantially normal to plane 26.

Core or void-producing elements 28 are generally elongate members such as, for example, foam backer rods or thin-walled tubes (generally resembling drinking or soda straws) which are, in some embodiments, encapsulated by cementitious material, and are carried by and remain in the finished product. The void-producing elements themselves provide no substantive resistance against deflection of siding members 12, 12a, and need not be joined (as through bonding adhesion, for example) to the cementitious material of the siding member. The purpose of the void-producing elements is to displace cementitious material in the siding member, to form voids 22 in the cementitious material that define web portions 24 of adjacent support portions 20. Core elements 28 may be substantially flexible, or semi-rigid, thereby facilitating the siding member's ability to be flexed to a minor degree to conform to surfaces in the ordinary manner of various siding types. That is, a certain degree of flexibility in the siding members to facilitate its installation on building sheathing, for example, is desirable.

Alternatively, certain embodiments of processes and systems for forming siding members in accordance with the present invention may incorporate the core or void-producing elements into an upper mold surface member that forms the reverse surface of the siding member, the core elements so incorporated into the upper mold surface member being configured to produce the siding member support portions. In such embodiments, webs 24, and spaces or voids 22 therebetween, define the profile of the formed siding member's reverse surface 30, whereas its exterior surface 18 remains substantially as shown in FIG. 2 or 2A, for example. Such an alternative molding system lends itself to an injection molding process, as described further below. In some embodiments of the siding member, its back side includes a substantially planar reverse face 30. In other embodiments, discussed below, the back side may have a reverse surface defined by the webs of support portions and the voids therebetween.

The siding members 12, 12a optionally include a reinforcement fabric 50, such as but not limited to fibers, scrims, netting, meshes, and/or the like, that can be added during formation or manufacture of the siding members 12, 12a, but are generally referred to as “meshed” reinforcement materials. Meshed reinforcement fabric 50 may be, for example, continuous strand natural fiberglass mat having a weight of approximately 0.75 ounce per square foot. Moreover, the siding members optionally include one or a plurality of longitudinally-oriented reinforcement fibers as described in above-mentioned U.S. Provisional Patent Application No. 61/145,592.

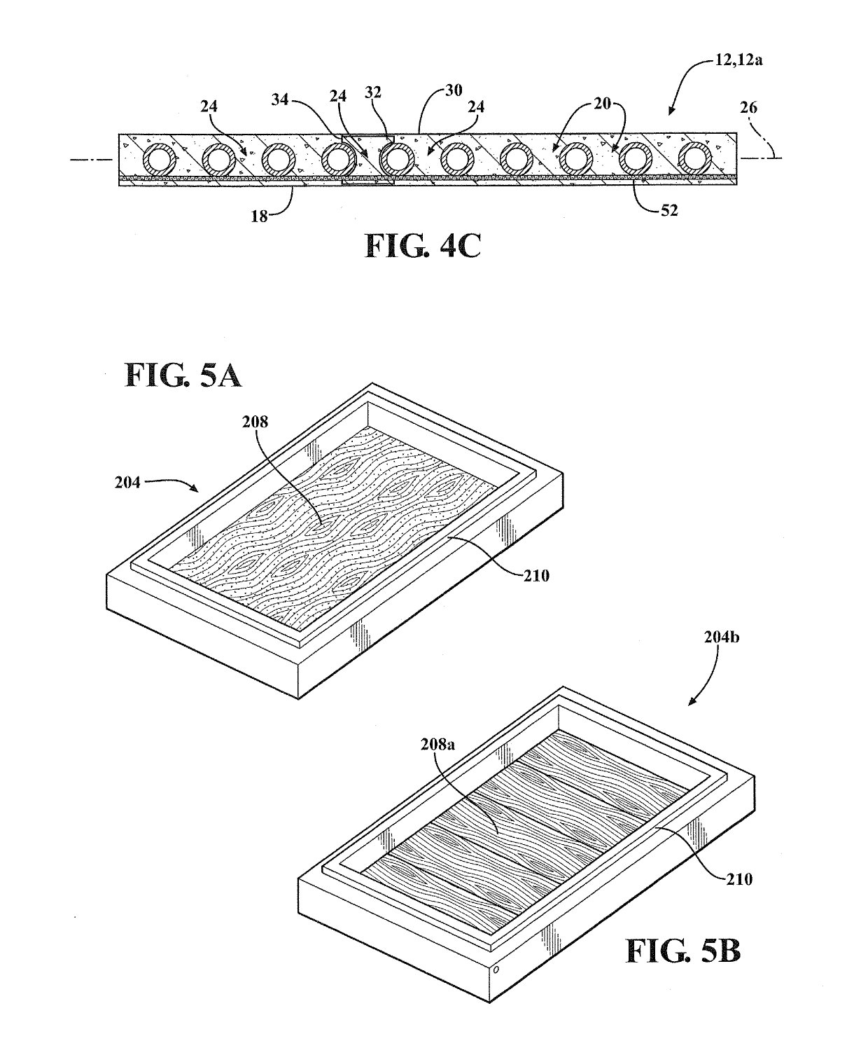

Referring to FIGS. 3, and 4A-4C, by way of non-limiting examples, the cementitious slurry is permitted to surround and at least partially envelop each of the elongate core or void producing elements 28 that remain in the finished product, and upon drying or curing, the cementitious material has a cross section in which the adjacent support portions 20 form a structure representing a plurality of parallel, laterally adjacent I-beams which impart increased strength that resists bending strain in siding member 12, 12a, markedly improving its ability to substantially maintain its natural, unflexed form when subjected to a bending load about an axis substantially perpendicular to the longitudinally axis of member 12, 12a. The weight of the siding member is also reduced due to the cementitious material displaced from the product by the void-producing elements. In certain embodiments of the siding members, webs 24 of support portions 20 extend between its flange portions 32 which are merged and integrally connected beneath the opposed surfaces or faces 18, 30 of the siding member, whereby each support portion 20 presents a cross section generally shaped like that of an I-beam. One such “I-beam” shape 34 is outlined in bold lines in FIGS. 4A and 4B. Alternative embodiments of the siding members described below include support portions that have only a single flange portion, from which the integral web portion extends.

The cementitious slurry is also permitted to infiltrate through the various crevices, apertures, or spaces, if present, formed in the meshed reinforcement fabric 50, if present, such that the meshed reinforcement fabric 50 is completely surrounded and enveloped by the cementitious slurry. The meshed reinforcement fabric 50 can aid in imparting increased strength, fracture resistance, and/or a desired degree of flexibility to the siding members 12, 12a.

Referring to FIG. 4C, scrim 52 to which core or void-producing elements 28 may be adhered can serve as, or be present in addition to, meshed reinforcement fabric 50. Scrim 52 is preferably placed on the side of plane 26 between core elements 28 and exposed, exterior siding face 18. Scrim may be sprayed, or otherwise provided with an adhesive material by which core elements 28 are maintained in position on scrim 52 and thus in the siding member, once properly oriented and positioned on the scrim.

In accordance with one aspect of the present invention, the siding member 12, 12a, apart from the core void-producing elements 28 and the optional reinforcement fabric 50 and/or scrim 52, is substantially formed from the cementitious slurry. The slurry can include hydraulic cement including, but not limited to, Portland, sorrel, slag, fly ash, or calcium alumina cement. Additionally, the cement can include a calcium sulfate alpha hemihydrate or calcium sulfate beta hemihydrate. The slurry can also utilize natural, synthetic, or chemically modified beta gypsum or alpha gypsum cement.

The cementitious slurry preferably includes gypsum cement and a sufficient amount of water added thereto to produce a slurry having the desired consistency, i.e., not too dry nor not too watery. In accordance with one aspect of the present invention, the water is present in combination with a latex material, such that the powdered gypsum material is combined with the latex/water mixture to form the cementitious slurry.

Gypsum is a naturally occurring mineral, calcium sulfate dihydrate, CaSO₄.2H₂O (unless otherwise indicated, hereafter, “gypsum” will refer to the dihydrate form of calcium sulfate). After being mined, the raw gypsum is thermally processed to form a settable calcium sulfate, which can be anhydrous, but more typically is the hemihydrate, CaSO₄.½H₂O, e.g., calcined gypsum. For the familiar end uses, the settable calcium sulfate reacts with water to solidify by forming the dihydrate (gypsum). The hemihydrate has two recognized morphologies, alpha and beta hemihydrate. These are selected for various applications based on their physical properties. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention, either or both of the alpha or beta forms can be used, depending on the mechanical performance required. The beta form generates less dense microstructures and is preferred for low density products. Alpha hemihydrate could be substituted for beta hemihydrate to increase strength and density or they could be combined to adjust the properties.

The cementitious slurry can also include other additives. The additives can include, without limitation, accelerators and set preventers or retarders to control the setting times of the slurry. For example, appropriate amounts of set preventers or retarders can be added to the mixture to increase the shelf life of the resulting slurry so that it does not cure prematurely. When the slurry is to be used in molding operations, a suitable amount of an accelerator can be added to the slurry, either before or after the pouring operation, so as to increase the drying and/or curing rate of the slurry. Suitable accelerators include aluminum sulfate, potassium sulfate, and Terra Alba ground gypsum. Additional additives can be used to produce colored siding systems 10, 10a, such as dry powder metallic oxides such as iron and chrome oxide and pre-dispersed pigments used for coloring latex paints.

In accordance with one aspect of the present invention, the cementitious slurry includes a gypsum cement material, such as but not limited to calcined gypsum (e.g., calcium sulfate hemihydrate), also commonly referred to as plaster of Paris. One source of a suitable gypsum cement material is readily commercially available from United States Gypsum Company (Chicago, Ill.) and is sold under the brand name HYDROCAL® FGR 95. According to the manufacturer, HYDROCAL® FGR 95 includes more than 95 wt. % plaster of Paris and less than 5 wt. % crystalline silica.

The gypsum cement material should include an approximate 30% consistency rate. That is, for a 10 lb. amount of gypsum cement material, approximately 3 lbs. of water of would be needed to properly activate the gypsum cement material. If a latex/water mixture is being used to create the cementitious slurry, and the mixture contains approximately 50 wt. % latex solids, then approximately 6 lbs. of the latex/water mixture would be needed, as the latex/water mixture only contains approximately 50 wt. % water, the remainder being the latex solids themselves.

In accordance with another aspect of the present invention, the cementitious slurry includes a melamine resin, e.g., in the dry form, which acts as a moisture resistance agent. The melamine resin is present in an amount of about 10% of the weight of the gypsum cement material. For example, if 10 lbs. of gypsum cement material are used, then approximately 1 lb. of the melamine resin would be used. One source of a suitable melamine resin is readily commercially available from Ball Consulting Ltd. (Ambridge, Pa.).

In accordance with still another aspect of the present invention, the cementitious slurry includes a pH adjuster, such as but not limited to ammonium chloride, a crystalline salt, which acts to ensure proper cross-linking of the latex/water mixture with the dry ingredients, especially the melamine resin. The ammonium chloride is present in an amount of about 1% of the weight of the gypsum cement material. For example, if 10 lbs. of gypsum cement material are used, then approximately 0.1 lbs. of the ammonium chloride would be used. One source of a suitable ammonium chloride is readily commercially available from Ball Consulting Ltd. (Ambridge, Pa.).

In accordance with yet another aspect of the present invention, the cementitious slurry includes a filler such as but not limited to fly ash (e.g., cenosphere fly ash), which acts to reduce the overall weight and/or density of the slurry. The fly ash is present in an amount of about 30% of the weight of the gypsum cement material. For example, if 10 lbs. of gypsum cement material are used, then approximately 3 lbs. of the fly ash would be used. One source of a suitable fly ash is readily commercially available from Trelleborg Fillite Ltd. (Runcorn, England).

Several of the wet and/or dry components of the cementitious slurry of the present invention are readily commercially available in kit form from the United States Gypsum Company under the brand name REDI-ROCK®. Additional information regarding several suitable components of the cementitious slurry of the present invention can be found in U.S. Pat. No. 6,805,741, the entire specification of which is expressly incorporated herein by reference.

One or more of the dry ingredients are to be combined with the liquid portion of the cementitious slurry, i.e., the latex/water mixture. If the latex/water mixture includes 50 wt. % latex solids, with the rest being water, then the latex/water mixture is present in an amount of about 60% of the weight of the gypsum cement material. For example, if 10 lbs. of gypsum cement material are used, then approximately 6 lbs. of the latex/water mixture would be used. One source of a suitable latex/water mixture is readily commercially available from Ball Consulting Ltd. (Ambridge, Pa.) under the brand name FORTON® VF-812. According to the manufacturer, FORTON® VF-812 is a specially formulated, all acrylic co-polymer (50% solids) which cross links with a dry resin to make the system moisture resistant and UV stable.

The resulting cementitious slurry of the present invention should possess the following attributes: (1) it should stay wet or flowable for as long as possible, e.g., days, weeks, months, as circumstances warrant; (2) it should self level, i.e., the slurry should level by itself without intervention from the user when introduced into or onto a mold face surface; and (3) it should contain a limited water content (e.g., compared to conventional gypsum cement slurries), i.e., it should not be so wet so as to take a very long time (e.g., several hours or even days) to dry or cure.

Alternatively, the slurry can be created on demand, as needed from a water and dry components mixed therewith, avoiding the need to store a mixed volume of cementitious slurry.

Alternatively, the cementitious slurry can be a mixture of rapidly setting hydraulic cement (not a Portland cement) that may or may not contain fiberglass fillers. RapidSet Construction Cement manufactured by CTS Cement Manufacturing Corp. of Cypress, Calif. (www.RapidSet.com) is an acceptable alternative to the above-discussed Gypsum/Latex material, although it is somewhat more brittle and sets in a short time, necessitating its being mixed in rather small batches that can be quickly used. This hydraulic cement is, however, much cheaper than the Gypsum/Latex mixture, and bonds better to fiberglass.

In accordance with one aspect of the present invention, a reinforcing material can also be disposed within the cementitious slurry, either prior to or after the introduction of the water thereto. The reinforcing material can include, without limitation, fibers, e.g., either chopped or continuous fibers, comprising at least one of polypropylene fibers, polyester fibers, glass fibers, and/or aromatic polyamide fibers. By way of a non-limiting example, the reinforcing material can include a combination of the fibers, such as the polypropylene fibers and the glass fibers or the polyester fibers and the glass fibers or a blend of the polypropylene fibers and the polyester fibers and the glass fibers. If included in the fiber composition, the aromatic polyamide fibers are formed from poly-paraphenylene terephthalamide, which is a nylon-like polymer commercially available as KEVLAR® from DuPont of Wilmington, Del. Of course, aromatic polyamide fibers other than KEVLAR® are suitable for use in the fiber composition of the present invention.

The cementitious slurry can then be mixed, either manually or automatically, so as to adequately combine the various ingredients thereof and optionally can also be agitated, e.g., by a vibrating table, to remove or lessen any air bubbles that formed in the cementitious slurry.

Referring to FIGS. 5A-11, illustrative systems and methods of forming a siding member 12, 12a of the present invention may include substantially open mold system 200. The depicted mold has a length shown as being much shorter that what may be employed in practice, for elongate member 12, 12a would normally have a length of several feet, and may have a height or width of only one foot or less.

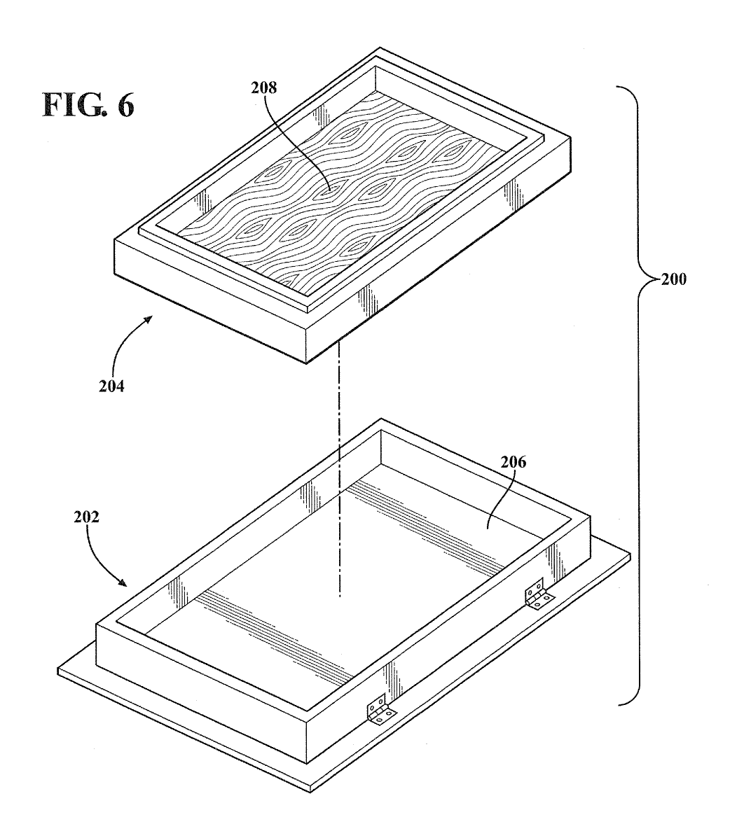

With specific reference to FIGS. 5A and 6, mold system 200 may include a lower or bottom lower mold retainer support 202, and a mold surface member 204 preferably disposed within a cavity 206 formed in the lower or bottom lower mold retainer support 202. Although the lower or bottom lower mold retainer support 202 is shown as being an open shell having a substantially rectangular configuration, the lower or bottom lower mold retainer support 202 can have any number of various configurations. Referring specifically to FIG. 5B, an alternative mold surface member 204a is shown for producing siding system 10a, i.e., the face 208a is essentially a negative image of the desired front and/or side exterior surface shape of the siding member 12a.

The mold surface member 204 or 204a can be formed of any type of material, such as rigid or flexible materials; however, preferably the mold surface member 204 or 204a is formed from a suitably flexible material that, e.g., can be removed from the cavity 206 (e.g., rubber, silicone, urethane and/or the like). The respective face 208 or 208a of the mold surface member 204 or 204a is essentially a negative image of the desired front and/or side exterior surface shape of the siding member 12 or 12a. Additionally, the mold surface member 204 or 204a preferably includes a peripheral lip member 210 (FIGS. 5A, 5B) to aid in grasping the mold surface member 204, 204a, e.g., when it is desired to remove the mold surface member from the cavity 206.

Although the following description will be directed primarily toward the production of siding member 12, it should be understood that the methodologies disclosed herein are equally applicable to the production of siding member 12a (provided that mold surface member 204a having face 208a is employed).

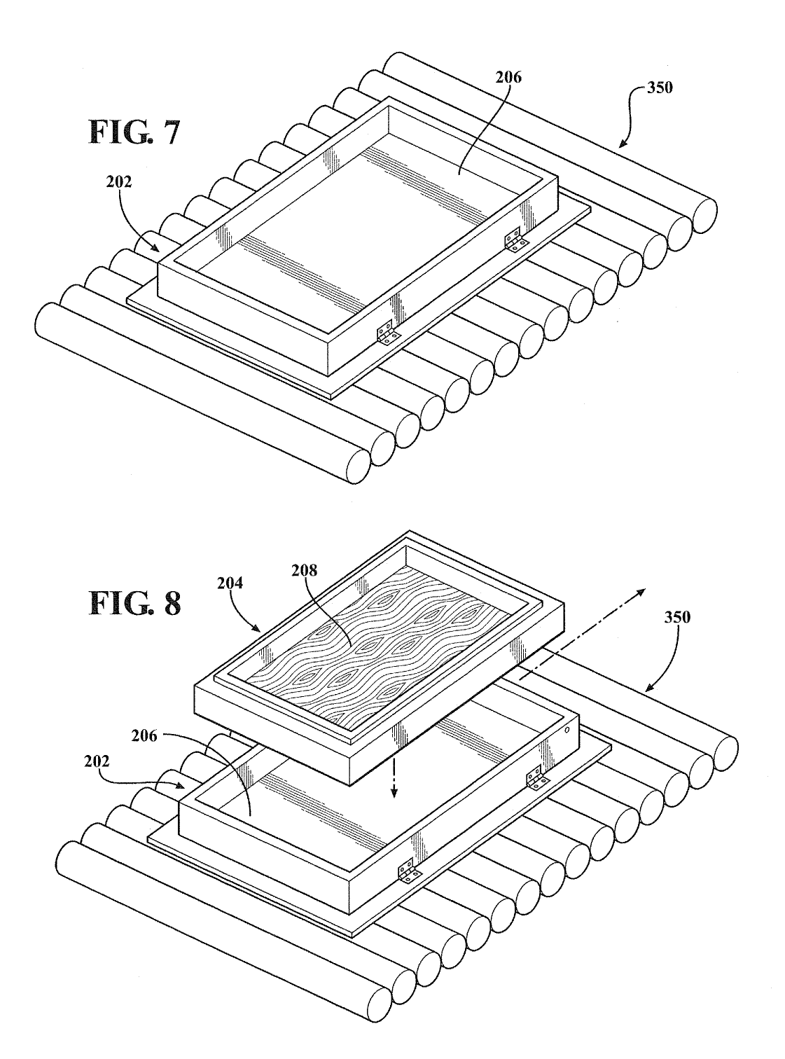

Referring specifically to FIGS. 7 and 8, because of the weights involved of the various components, as well as the cementitious slurry, a transport device, such as a conveyor system 350, either manually or automatically operated, can be employed to guide the mold system 200 along during the manufacturing process, e.g., from an initial processing station, to a curing station, and finally to a product removal station. In this manner, many siding members 12 can be produced sequentially and rapidly (e.g., in an assembly line process) without having to wait for each individual siding system to be finally and completely manufactured.

As previously noted, in order to provide siding member 12 of various colors to satisfy consumer demand, the cementitious slurry can contain colorants dispersed therethrough, or alternatively, the face 208 of the mold surface member 204 can be coated with a colorant, or in the case of a “natural cedar shake” effect, a series of colorants can be provided to produce a multi-colored and/or variegated siding member 12. Furthermore, it should be noted that paints, stains, sealants, and/or the like can also be applied to the face 208 of the mold surface member 204 before the introduction of the cementitious slurry, or alternatively, they can be applied to the finished product after removal from the mold surface member 204. This process can be done in a factory setting or at a worksite, by either the installer or the homeowner.

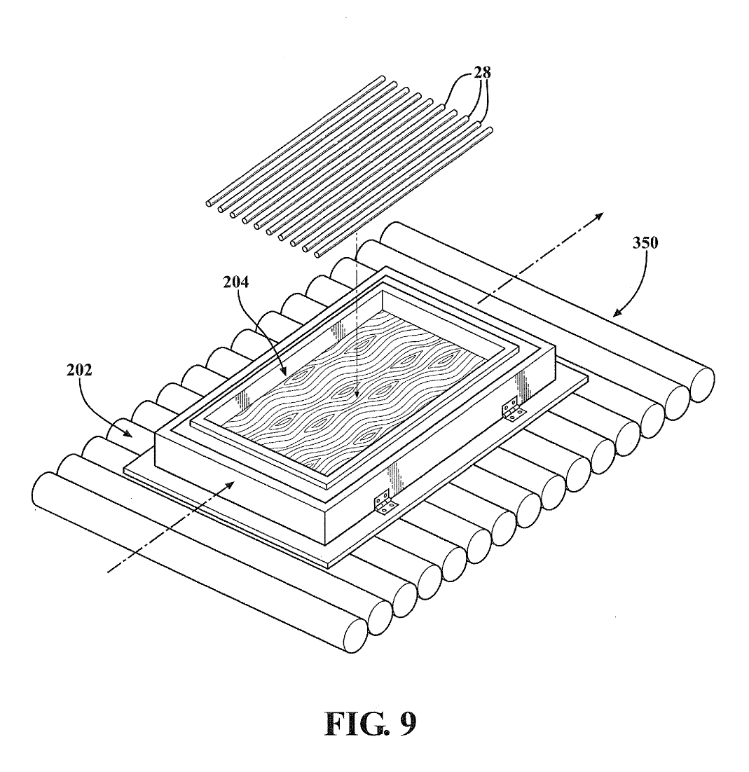

Referring specifically to the embodiments depicted in FIGS. 8 and 9, with mold surface member 204 having been placed in cavity 206 of support 202, a plurality of longitudinally-oriented core or void-producing elements 28 arranged substantially in parallel with each other and spaced about ½ inch apart, center-to-center, are placed in mold surface member 204, with core elements 28 extending longitudinally along and to the longitudinally opposite ends of mold surface face 208 and, consequently, the siding member 12 to be formed therein.

Mold surface member 204 having been placed in cavity 206 of support 202, reinforcement fabric 50 is optionally placed in the mold surface member 204, and if so preferably in proximity to the face 208 of the mold surface member 204. Because it is desired that the cementitious slurry be allowed to infiltrate through the meshed reinforcement fabric 50, if used, it is desirable to leave a space between the meshed reinforcement fabric 50 and the face 208 of the mold surface member 204 such that the flowing cementitious slurry can fill the area therebetween and prevent any “read through” of the meshed reinforcement fabric 50 on the finished surface of the siding member 12.

Optionally, one or more longitudinally-oriented reinforcement fiber bundles may be incorporated into the process and molded product as described in above-mentioned U.S. Provisional Application Ser. No. 61/145,592.

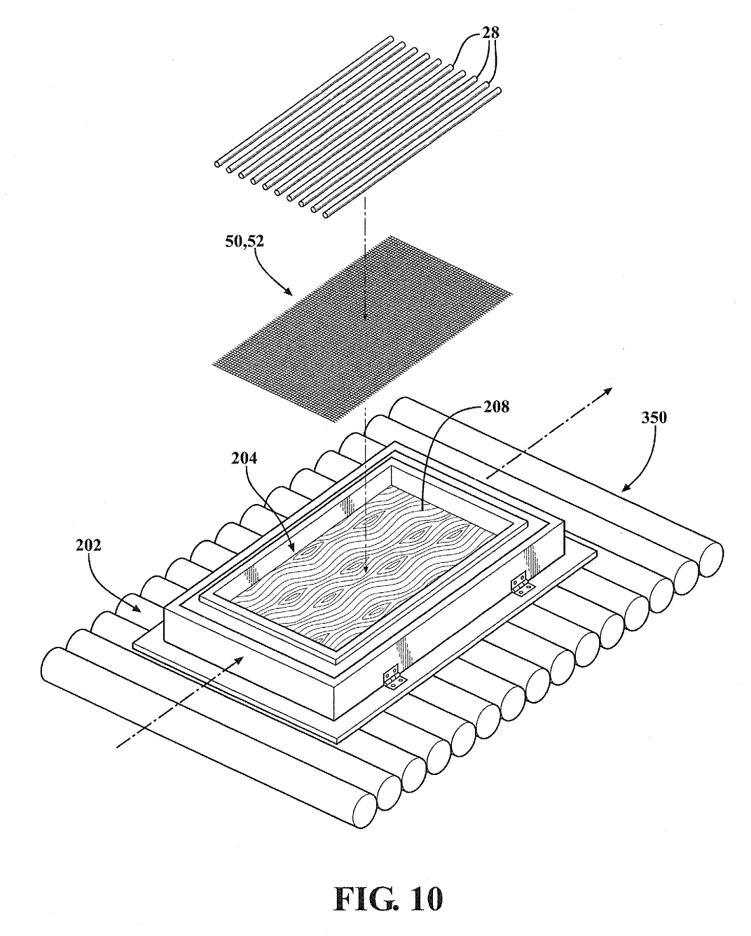

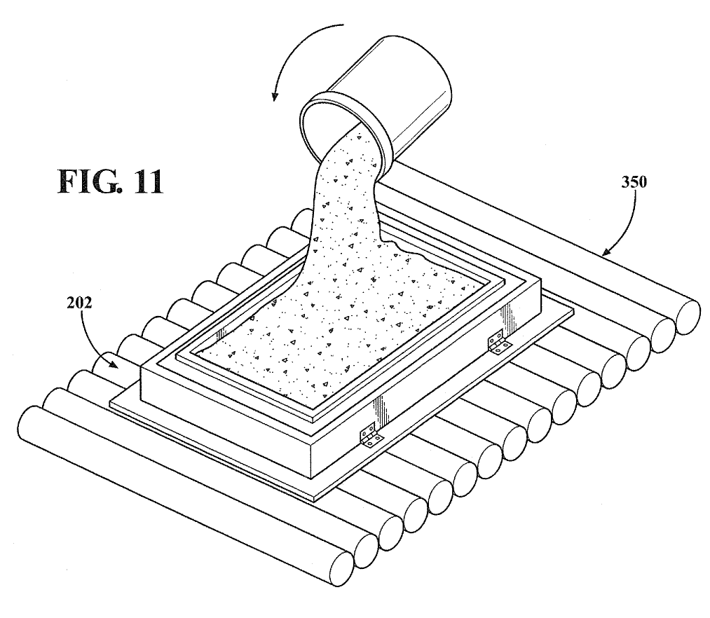

Referring to FIG. 10, this process may be modified by inserting scrim 52, which may be, or may be additional to, reinforcement fabric 50, into mold surface member 204. Scrim 52 has an adhesive applied to it by which core elements 28, once properly oriented and positioned, are maintained in their desired orientation during the molding process, and thus in the finished product. Notably, core elements 28 may be affixed to scrim 52 prior to scrim 52 being placed in mold surface member 204, or subsequent to scrim 52 or core elements 28 being placed in mold surface member 204.

In the open mold system 200, a means for orienting void-producing elements relative to the mold face 208 includes placement of elements 28 manually or through use of a suitable positioning jig or gage (not shown), onto the mold face 208 or onto the optional reinforcement material fabric 52.

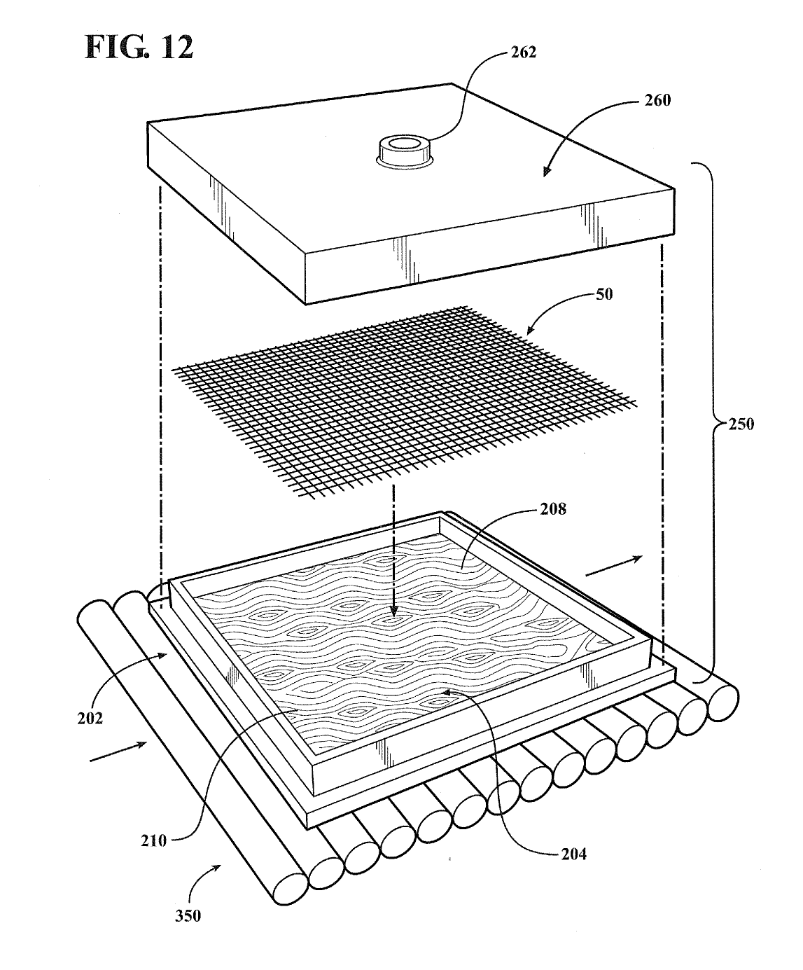

Referring specifically to FIG. 11, after the cementitious slurry has been prepared, as described above, the cementitious slurry, preferably while still wet, is then introduced into the mold surface member 204, either manually or mechanically, such that it contacts and fills the mold surface member 204 to a desired depth, enveloping core elements 28, and scrim 52 or other meshed reinforcement fabric 50, if present, disposed in the mold cavity. By way of a non-limiting example, the cementitious slurry is sprayed or poured onto the mold surface member 204 until it reaches a height flush with the upper surface of peripheral lip 210 of mold surface member 204. Alternatively, the amount of the cementitious slurry could be added on the basis of weight, as opposed to volume. However, it should be appreciated that either less than or more than this amount (e.g., volume and/or weight) of the cementitious slurry can be used, e.g., depending on the specific application.

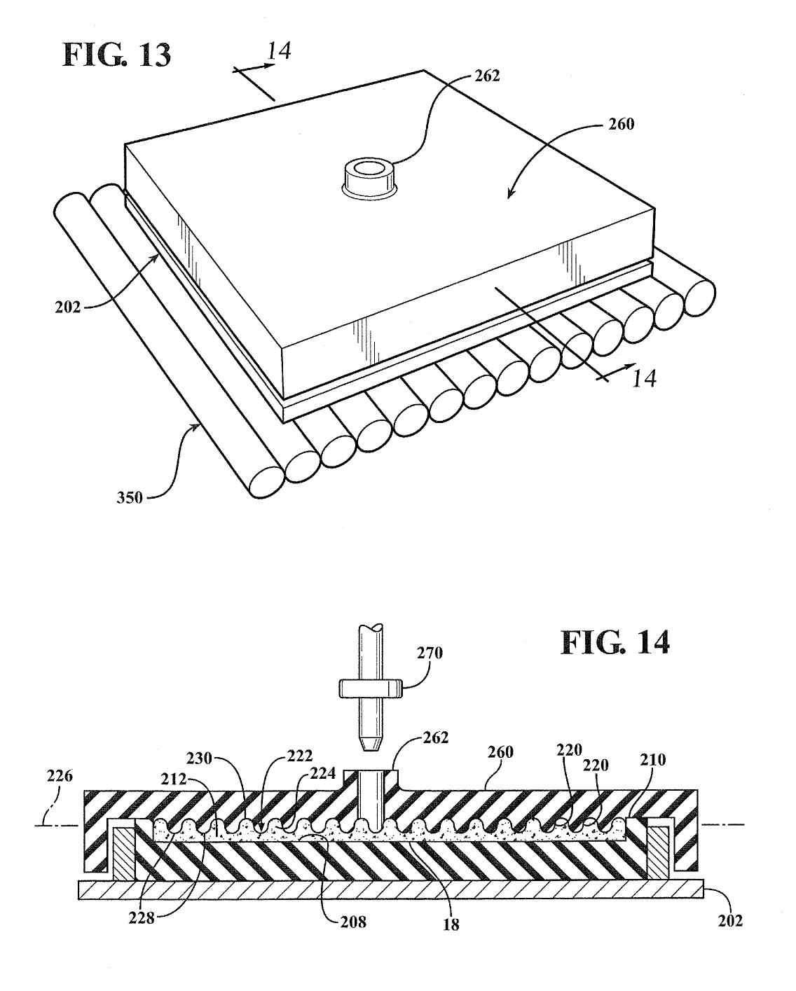

It is to be understood that the above-described processes are but examples of how longitudinally-oriented core elements 28 might be arranged for molding siding member 12 in a substantially open molding or casting process. Any suitable method for longitudinally arranging core elements 28 within the mold to effect the formation of support portions 20 in siding member 12 may be alternatively employed, including, for example, employing an upper mold surface member that is interfitted with lower mold surface member 204 to form and arrangement of longitudinally extending voids 22 and webs 24 in reverse face 30 of the molded siding member, although defining a siding member reverse face that is other than substantially flat. Referring to FIGS. 12-14, such a system of molding siding member 12 is illustrated.

Closed mold system 250, which utilizes mold retainer support 202 and lower mold surface member 204 substantially as described above, preferably in conjunction with conveyor system 350, but which also includes upper mold surface member 260 interfitted with lower mold surface member 204, is used in an injection molding process. Upper mold surface member 260 includes sprue 262 through which the slurry is introduced to the closed mold. Referring to FIG. 14, upper mold surface member 260 has a mold surface configured to form an arrangement of longitudinally extending webs 224 and voids 222 in reverse face 230 of molded siding member 212. The mold surface of upper mold surface member 260 is provided with an arrangement of integrally-formed core or void-producing elements 228 that lie in plane 226 substantially coinciding with a plane defined by the illustrated siding member 212 within the closed mold. Slurry is injected into the closed mold cavity through sprue 262, into which injection nozzle 270 is inserted by an operator. The injection of slurry into the closed mold may be on a volume basis, or a timed shot.

In the closed mold system 250, a means for orienting void-producing elements relative to the mold face 208 includes the arrangement of void-producing elements 228 provided on the mold surface of upper mold surface member 260 which is placed into operative engagement with lower mold surface member 204 during injection of the cementitious material slurry.

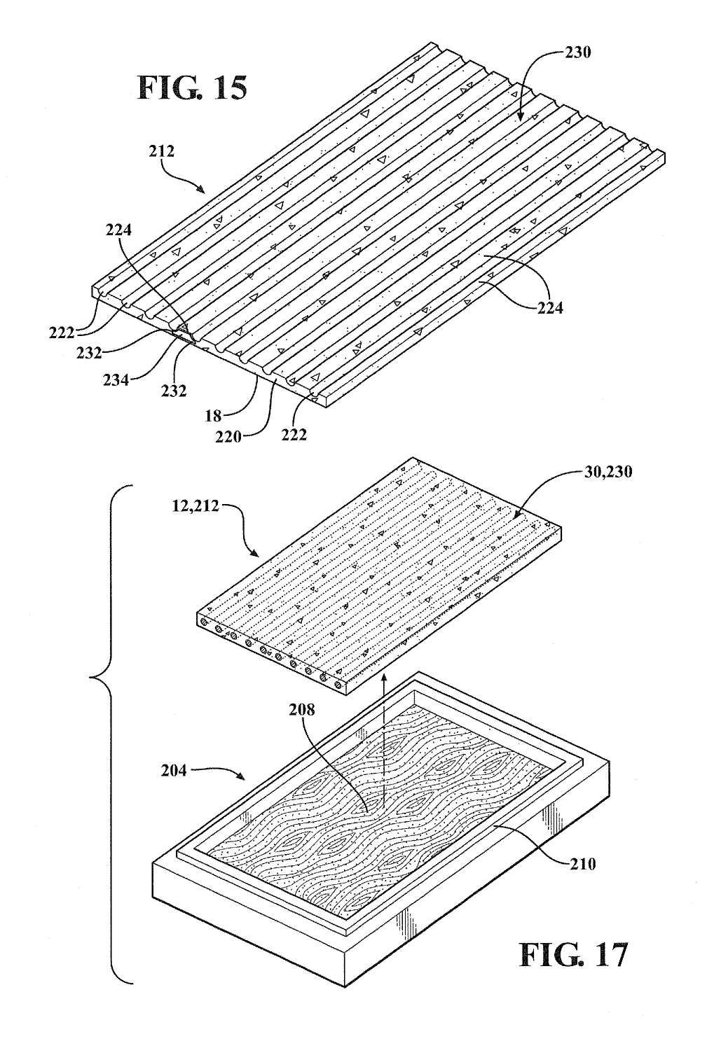

FIG. 15 depicts a siding member 212 formed by an injection molding process utilizing closed mold system 250. As viewed in cross section, the ends of the webs 224 of adjacent support portions 220 that are disposed proximate to exterior siding member surface 18 extend into flange portions 232, which are merged and integrally connected beneath exposed, exterior face 18 the siding member 212. Thus, each support portion 220 presents a cross section generally shaped like that of an I-beam. One such I-beam shape 234 is outlined in bold lines in FIG. 15. The back side of member 212 has laterally undulating, or longitudinally ribbed, reverse surface 230 defined by web portions 224 of support portions 220, and voids 222 therebetween.

Regardless of whether a siding member is formed by an open molding or casting process utilizing system 200, or an injection molding process utilizing closed mold system 250, the cementitious slurry is then allowed to dry, harden or cure for a sufficient amount of time, which may depend, at least in part, on the specific composition of the cementitious slurry used. The mold system 200 or 250 can also be shuttled off of the conveyor system 350 and stored in a storage area (not shown) so that other siding systems 10 can be made in the interim.

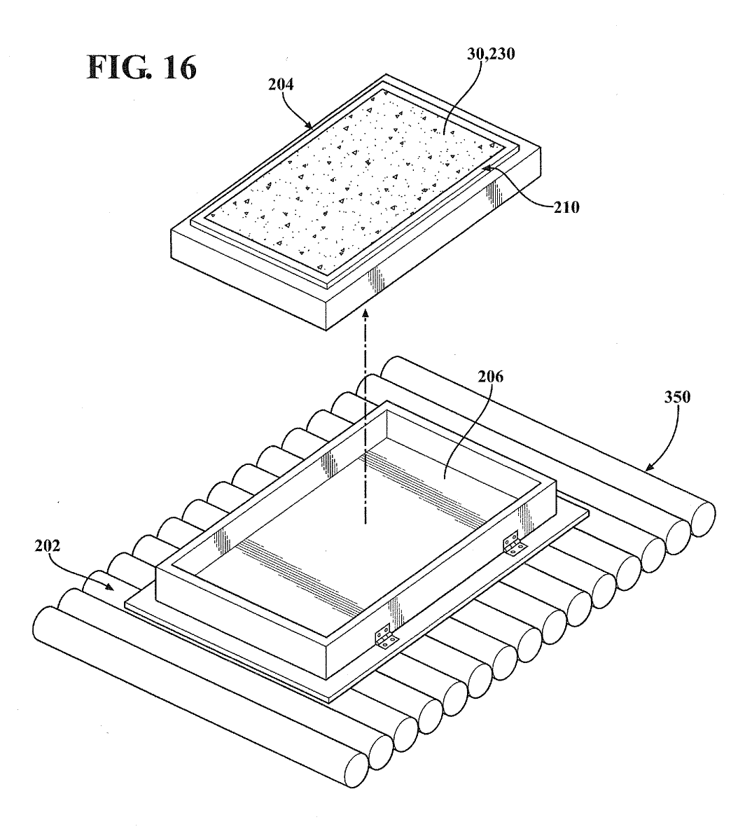

Referring specifically to FIGS. 16 and 17, once the cementitious slurry has dried, hardened or cured, the siding member 12 or 212 can then be removed from the mold system 200 or 250. For example, if present, upper mold surface member 260 is removed from mold surface member 204, and mold surface member 204 may be removed from the cavity 206 by grabbing the peripheral lip member 210 and lifting the mold surface member 204 upwardly and out of the cavity 206. The mold surface member 204 is removed from the siding member 12, 212, thus exposing the finished product, which is preferably allowed to dry to a suitable extent, after which time it can then be used immediately or further processed as necessary. As shown in FIGS. 16 and 17, features of molded siding member 12 are depicted in solid lines, whereas unique features of superimposed siding member 212 are shown in ghosted lines, the respective features of each to be understood with reference to the above.

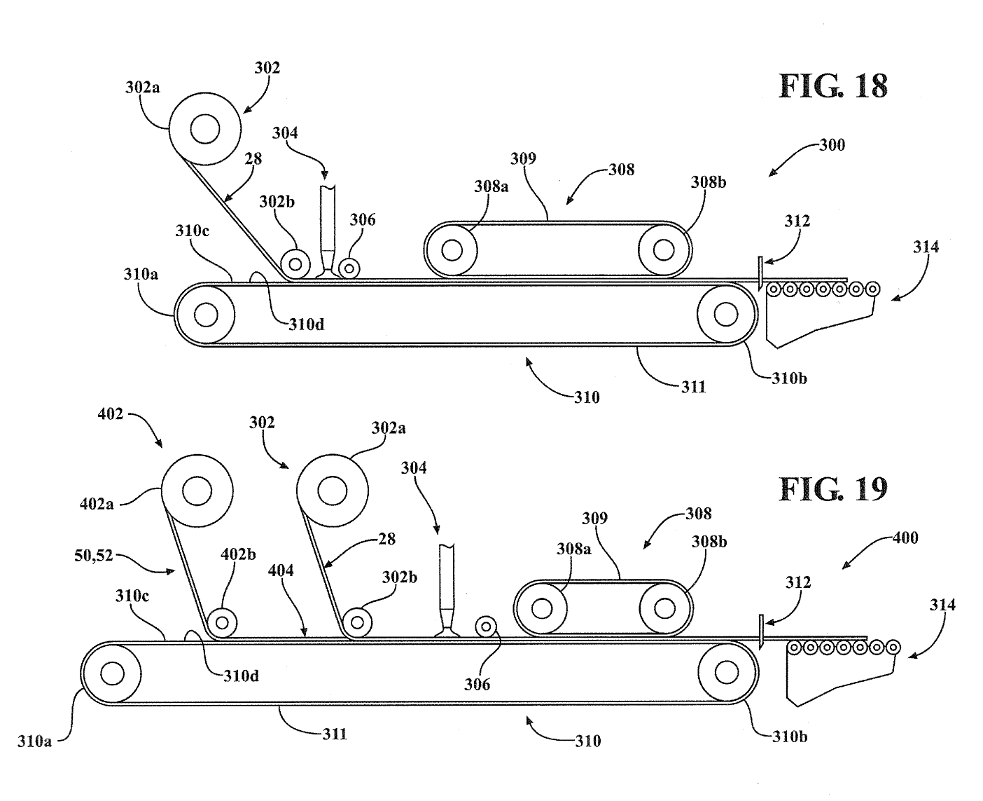

Referring now to FIG. 18, there is shown a schematic view of a first alternative system 300 for producing cementitious siding members 12, 12a. System 300 provides a continuous method for producing relatively long lengths of the siding that can be cut to an appropriate size, resulting in members 12, 12a, without the need to produce individual siding members of limited size. The system 300 primarily includes a core or void-producing element feed roller system 302 (including rollers 302a and 302b), a cementitious slurry feed system 304, a slotted roller 306, a top roller system 308 (including rollers 308a and 308b, and endless belt 309 extending thereover) and a bottom roller system 310 (including rollers 310a and 310b, and endless belt 311 extending thereover).

Initially, parallel continuous lengths of parallel core elements 28, preferably spaced about ½ inch apart, are fed via core element feed roller system 302 onto the surface 310c of bottom roller system 310. Roller 302a may be provided with rotational resistance to provide a desired amount of drag on core elements 28 wound thereabout, and a sufficient amount of tensile stress in core element 28 as may be required for providing a pulling force on the core element leading ends to take up slack and set the core elements 28 into the molding process. Once the process has begun, however, the cementitious material of the siding product exiting system 300 will have sufficiently cured to capture the core elements 28 being received into system 300, and exert the necessary pulling force on the core elements 28 being unwound from roller 302a to eliminate any slack in the core elements.

An appropriate amount of the cementitious slurry is placed onto the core elements via the cementitious slurry feed system 304. The slotted roller 306 (or other appropriate roller or other device) rotates over the cementitious slurry to maintain the appropriate position of core elements 28 relative to the thickness of the siding member 12. Slotted roller 306 ensures core elements 28 are immersed into and enveloped by the slurry. Notably, slurry feed system 304 could alternatively be located downstream of slotted roller 306a.

As the cementitious slurry/core elements 28 combination travels through the top roller system 308 and bottom roller system 310, with core elements 28 maintained in tension sufficient to at least prevent any slack therein, the cementitious slurry is contacted by a textured face 310d formed on the surface 310c of belt 311 of the bottom roller system 310. The textured face 310d includes a pattern that is operable to impart the appropriate siding pattern onto the adjacent surface of the cementitious slurry. The finished siding system then passes out through the top roller system 308 and bottom roller system 310 and can be cut by an optional cutting device 312 (e.g., a transverse saw) into siding systems of appropriate length. The cut siding members 12 received from the outlet of system 300 can be fed onto an optional conveyor system 314 for packaging or shipment purposes.

In continuous molding system 300, a means for orienting void-producing elements relative to the mold face 310c includes feed roller system 302, and the cementitious slurry which pulls the parallel lengths of core element 28 therefrom, and positions them relative to the mold face.

Alternatively, in continuous molding system 300, a means for orienting void-producing elements relative to the mold face 310c upper roller system may include a belt 309 on the outer surface of which is formed a plurality of longitudinally extending parallel ribs (not shown), which can be used instead of void-producing element feed roller system 302 and encapsulated elements 28, which may be omitted. Such an alternative system 300 yields a continuously-formed siding member having reverse surface that is laterally undulating, or longitudinally ribbed, similar to that of above-described member 212; that is, having a reverse surface defined by a plurality of longitudinally oriented web portions and voids therebetween, and revealed when the cured siding is separated from belt 309.

Referring now to FIG. 19, there is shown a schematic view of a second alternative system 400 for producing the cementitious siding of the present invention, i.e., siding members 12, 12a. System 400, like system 300, also provides a continuous method for producing relatively long lengths of the siding that can be cut to an appropriate size, resulting in members 12, 12a, without the need to produce individual siding members of limited size. The system 400 is very similar to system 300 depicted in FIG. 18 and/or described above, and likewise includes a core or void-producing element feed roller system 302, a cementitious slurry feed system 304, a slotted roller 306, a top roller system 308 (including rollers 308a and 308b, and endless belt 309 extending thereover) and a bottom roller system 310 (including rollers 310a and 310b, and endless belt 311 extending thereover). However, system 400 differs by inclusion of a fabric feed system 402, by which reinforcement fabric 50, which may include scrim 52 is provided to the process and product.

As with the system 300 depicted in FIG. 18 and/or described above, parallel, continuous lengths of core elements 28, preferably spaced about ½ inch apart, are fed via feed roller system 302 (including rollers 302a and 302b) onto the surface 310c of bottom roller system 310. An appropriate amount of the cementitious slurry is placed onto the core elements 28 via the cementitious slurry feed system 304. The slotted roller 306 (or other appropriate roller or other device) rotates over the cementitious slurry to hold the core elements 28 at the appropriate position within the thickness of the siding member. Also as with the system 300 depicted in FIG. 18 and/or described above, roller 302a may be provided with rotational resistance to provide a desired amount of drag on core elements 28, whereby any slack in core elements 28 is eliminated, and a sufficient amount of tensile stress in the core elements 28, if desired, is created. Also, as with the system 300 depicted in FIG. 18 and/or described above, the initial feeding of core elements 28 through system 400 may require providing a pulling force on the core element leading ends to take up slack and set the core elements into the molding process. Also, as with the system 300 depicted in FIG. 18 and/or described above, once the process has begun, the cementitious material of the siding product exiting system 400 will have sufficiently cured to capture the core elements 28 being received into system 400, and exert the necessary pulling force on the continuous core elements being unwound from roller 302a to eliminate any slack in the core elements 28, or provide tensile stressing thereof, if desired. Also as with the system 300 depicted in FIG. 18 and/or described above, slotted roller 306 ensures core elements 28 are properly positioned relative to the thickness of the siding member, and immersed into and enveloped by the slurry, and slurry feed system 304 could alternatively be located downstream of slotted roller 306.

However, in this embodiment, a continuous length of reinforcement fabric 50 is fed via fabric feed system 402 (including rollers 402a and 402b) onto surface 310c of bottom roller system 310.

As described above, reinforcement fabric 50 may be, or be in addition to, scrim 52. If in addition to scrim 52, an additional feed roller system (not shown) would be added upstream or downstream of feed roller system 402 for either reinforcement fabric 50 or scrim 52, as would be understood by one of ordinary skill in the art. Further discussion of system 400 below relates to fabric 50 being scrim 52.

As noted above, scrim 52 preferably has an adhesive applied thereto, as via a suitable known roller applicator or sprayer positioned at 404, is fed via fabric feed system 402 (including rollers 402a and 402b) onto surface 310c of bottom roller system 310, the core elements 28 being affixed to the scrim to ensure their proper positions are maintained through out the molding process, and consequently in the finished product.

As the cementitious slurry/scrim 52/core element 28 combination travels through the top roller system 308 and bottom roller system 310, the cementitious slurry is contacted by a textured face 310d formed on the surface 310c of the bottom roller system 310. The textured face 310d includes a pattern that is operable to impart the appropriate siding pattern onto the adjacent surface of the cementitious slurry. The finished siding system then passes out through the top roller system 308 and bottom roller system 310 and can be cut by an optional cutting device 312 (e.g., a transverse saw) into siding systems of appropriate length, whereupon the cut siding systems can be fed onto an optional conveyor system 314 for packaging or shipment purposes.

In system 400, roller 306 may be modified to ensure that the slurry is forced through scrim 52 and reaches surface 310c of bottom roller system 310, whereby scrim 52 is immersed and encapsulated by the slurry. Notably, with the addition of scrim 52, providing a separate pulling force on core elements 28, or relying on the partially cured slurry to capture the core elements 28, in order to eliminate slack therein can be eliminated in favor of initially feeding scrim 52 into the molding system, adhering the core elements 28 to the scrim with the adhesive applied thereto, and relying on scrim 52 being pulled by the partially cured slurry through system 400. Thus, the adherence of core elements 28 to scrim 52 will provide sufficient tension in the core elements 28 to eliminate any slack in the parallel core element lengths.

In continuous molding system 400, a means for orienting void-producing elements relative to the mold face 310c includes feed roller system 302, and the cementitious slurry and/or the reinforcement material fabric 52 with adhesive applied, which pulls the parallel lengths of core element 28 from feed roller system 302 and positions them on the mold face.

Alternatively, in continuous molding system 400, a means for orienting void-producing elements relative to the mold face 310c upper roller system may include a belt 309 on the outer surface of which is formed a plurality of longitudinally extending parallel ribs (not shown), which can be used instead of void-producing element feed roller system 302 and encapsulated elements 28, which may be omitted. Such an alternative system 400 yields a continuously-formed siding member having reverse surface that is laterally undulating, or longitudinally ribbed, similar to that of above-described member 212; that is, having a reverse surface defined by a plurality of longitudinally oriented web portions and voids therebetween, and revealed when the cured siding is separated from belt 309.

Systems 300 and 400 and their respective processes may be further modified to optionally provide their resultant molded siding members with one or a plurality of longitudinally-oriented reinforcement fibers as described in above-mentioned U.S. Provisional Patent Application No. 61/145,592.

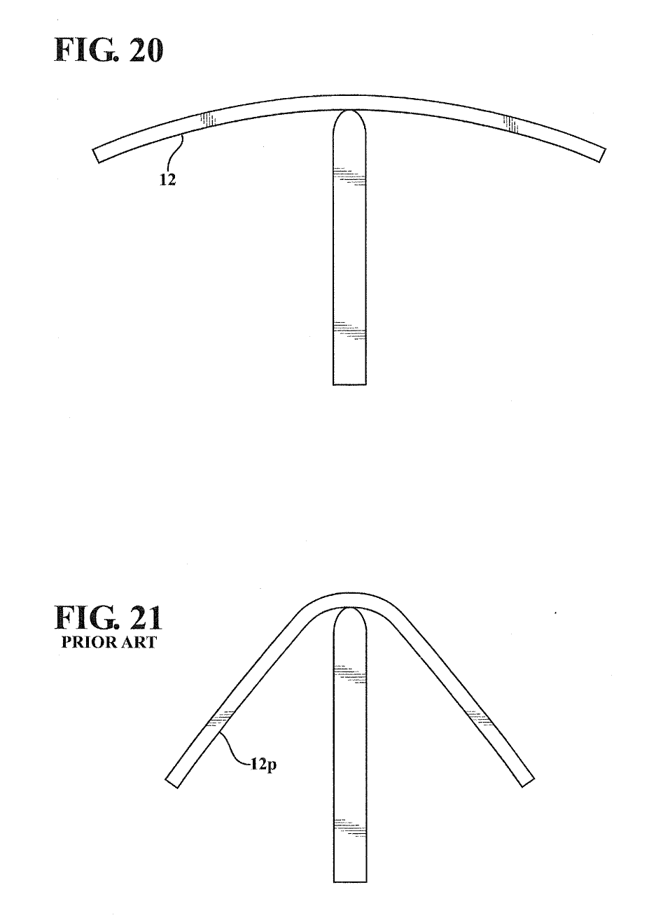

Referring to FIGS. 20 and 21, the effect on bending resistance afforded elongate siding member 12 (FIG. 20) by its being provided with longitudinally extending support portions 20 provided by the integrally-formed I-beam construction in accordance with the present invention, vis-á-vis otherwise identical siding member 12p according to the prior art (FIG. 21), is illustrated. Each of the siding members in FIGS. 20 and 21, exhibits some degree of bending when supported solely at its longitudinal mid-point, but the degree exhibited by siding member 12 of FIG. 20 provided with a plurality of longitudinally extending support portions 20 as described above, is markedly less, with the weight of siding member 12 being supported internally by the support portions 20, which have a moment of inertia sufficient for siding member 12 to better resist bending, thereby facilitating easier handling of member 12 with reduced risk of its cementitious material being cracked or broken.

While the invention has been described with reference to exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

1. A siding system comprising:
at least one elongate member molded of cementitious material and having opposed front and back sides, the front side formed of cementitious material and having a front exterior face located on one side of an imaginary plane, the member including a plurality of longitudinally-oriented support portions that extends substantially the entire length of the member, each support portion having a web portion that extends in a direction substantially normal to the plane and at least one flange portion, the webs of adjacent support portions separated by a longitudinally-oriented void in the cementitious material and located in the plane, flange portions located on the same side of the plane as the member front side integrally connected to each other;
wherein the support portions are subjected to compressive and tensile stresses during bending deformation of the member out of the plane, and the bending deformation of the member is resisted by the support portions.

2. The siding system of claim 1, wherein the void is defined by an elongate void-producing element carried by the member.

3. The siding system of claim 2, wherein the void-producing element is a foam core.

4. The siding system of claim 2, wherein the void-producing element is a semi-rigid tube.

5. The siding system of claim 2, wherein the void-producing element is at least partially encapsulated by cementitious material.

6. The siding system of claim 1, wherein the member back side has a reverse face defined by a plurality of voids and a plurality of support portions.

7. The siding system of claim 1, wherein the member back side has a reverse face defined by a substantially planar surface.

8. The siding system of claim 1, wherein the member back side has a reverse face that is longitudinally ribbed.

9. The siding system of claim 1, wherein the member comprises a meshed reinforcement material enveloped by the cementitious material, the meshed reinforcement material disposed between the front exterior face and the plane.

10. The siding system of claim 1, wherein the member front exterior face defines a textured pattern.

11. A molding system for forming an elongate siding member comprising a cementitious material that defines a plurality of longitudinally oriented support portions extending substantially the entire length of the siding member and longitudinally oriented voids in the cementitious material, the system comprising:
a mold face defining at least a portion of a front exterior surface of the siding member;
means for orienting void-producing elements relative to the mold face; and
a cementitious material source from which a desired amount of cementitious material is received onto the mold face and at least partially envelops the void-producing elements.

12. The molding system of claim 11, wherein the cementitious material source is that from which a desired amount of cementitious material is received onto the mold face and envelops a reinforcement fabric optionally disposed between the void-producing elements and the mold face.

13. The molding system of claim 11, wherein the void-producing elements are longitudinally oriented along the length of the elongate siding member through the means for orienting the void-producing elements.

14. The molding system of claim 11, further comprising a mold retainer support having a cavity and a mold surface member, the mold surface member disposed in the cavity and defining the mold face.

15. The molding system of claim 11, further comprising a void-producing element feed roller system from which continuous lengths of void-producing elements are received over the mold face, and a bottom roller system including the mold face, the mold face having continuous movement in a direction corresponding to the length of the siding member, the void-producing element feed roller system arranged such that void-producing elements received therefrom are positioned relative to the mold face and moved with cementitious material on the mold face.

16. The molding system of claim 15, wherein the bottom roller system comprises an endless belt on which is defined the mold face.

17. The molding system of claim 16, further comprising a top roller system comprising an endless belt having continuous movement and superposing the endless belt of the bottom roller system, the molding system having a path between the superposed belts along which siding member product is moved longitudinally through the molding system.

18. The molding system of claim 15, further comprising a reinforcement fabric feed roller system from which a continuous length of the reinforcement fabric is received over the mold face, the reinforcement fabric feed roller system arranged such that reinforcement fabric received therefrom is positioned relative to the mold face and moved with cementitious material on the mold face.

19. The molding system of claim 18, further comprising an adhesive applicator from which an adhesive is applied to one of the reinforcement fabric and the void-producing elements, the relative positioning of the reinforcement fabric and the void-producing elements during application of cementitious material within the system substantially maintained by the applied adhesive.

20. The molding system of claim 18, wherein the void-producing element feed roller system is downstream of the reinforcement fabric feed roller system and arranged to position void producing elements received therefrom over the reinforcement fabric.

21. The molding system of claim 18, wherein relative to the direction of mold face movement the cementitious material source is positioned downstream of the reinforcement fabric feed roller system.

22. The molding system of claim 15, wherein the cementitious material source is positioned downstream of the void-producing element feed roller system.

23. The molding system of claim 11, further comprising a cutting device by which cured molded siding member product once separated from the mold face is cut to a desired length.

24. An elongate siding member comprising a cementitious material that surrounds a plurality of void-producing elements extending substantially the entire length of the siding member received from the outlet of the molding system of claim 11.

25. A method of molding an elongate siding member comprising cementitious material having a plurality of integrally-formed longitudinally oriented cementitious material support portions which extends substantially the entire length of the siding member, comprising the steps of:
longitudinally-orienting void-producing elements over a mold face;
receiving cementitious material onto the mold face;
at least partially surrounding the void-producing elements with the cementitious material received onto the mold face;
forming a front exterior surface of the siding member and a plurality of integrally-formed longitudinally-oriented support portions which extends substantially the entire length of the siding member from the cementitious material received onto the mold face;
curing the formed cementitious material; and
separating the siding member and the mold face.

26. The method of claim 25, further comprising the steps of:
placing individual lengths of void-producing elements over the mold face;
capturing the void-producing elements within the cementitious material; and
carrying the captured void-producing elements in the siding member separated from the mold face.

27. The method of claim 25, further comprising the steps of:
introducing a meshed reinforcement material over the mold face; and
enveloping the meshed reinforcement material with the cementitious material received onto the mold face.

28. The method of claim 25, further comprising the step of imparting a pattern into the cementitious material received onto the mold face with the mold face.

29. The method of claim 25, wherein the step of longitudinally-orienting void-producing elements over a mold face is performed prior to the step of receiving cementitious material onto the mold face.

30. The method of claim 26, further comprising the step of separating the siding member and the void-producing elements.
